(19) United States
(12) Patent Application Publication
(10) Pub. No.: US 2010/0049943 A1
(43) Pub. Date: Feb. 25, 2010

(54) Programmable control pipeline architecture and pipeline processing system thereof

(75) Inventor: Hau-Tau Lan, Taipei City (TW)

Correspondence Address: BACON & THOMAS, PLLC, 625 SLATERS LANE, FOURTH FLOOR, ALEXANDRIA, VA, 22314-1176, US

(73) Assignee: CENTRAL DIGITAL INC., TORTOLA (VG)

(21) Appl. No.: 12/230,143

(22) Filed: Aug. 25, 2008

(51) Int. Cl. G06F 15/76; G06F 9/02

(52) U.S. Cl. 712/29; 712/E09.002

(57) ABSTRACT

The present invention provides a control pipeline architecture and a pipeline processing system thereof, which is applicable to digital and analog integrated circuit (IC) design flow for convenient hardware implementation. In which, a closed loop control pipeline architecture includes a plurality of control units, and each of the control units connected in series connection with one another to form a closed loop architecture to link an output of one control unit to an input of one next control unit; and an open loop control pipeline architecture included a plurality of control units, each of the control units connected in series connection with one another to form an open loop architecture to link an output of one control unit to an input of one next control unit.

### BACKGROUND

1. Field of The Invention

The present invention relates to a control pipeline architecture and a pipeline processing system thereof, and more particularly to a control pipeline architecture and a pipeline processing system thereof applicable to digital and analog integrated circuit (IC) design flow. With the present invention, new applications of data processing, data transmitting, delay module and phase locking frequency multiplying are developed.

2. Description of Prior Art

Implementations of traditional neural network are short of architectures applicable to digital and analog integrated circuit design flow. So, such applications of neural network are always implemented in algorithm by use of software operation, and are not able to be implemented by use of hardware circuit architecture. The way to have data processing in nodes and data transmitting between nodes of the neural network by use of hardware circuit or architecture is an important matter to be solved.

Besides, in common digital circuits, such as data processing, data transmitting, phase locking or frequency multiplying circuit, always lock signal by rising or falling edge of clock signal in signal sampling or phase locking to delay or memorize signal. Therefore, problems of setup time and hold time are started up, and appearance of jitter is happened either.

Traditional digital circuits grab or process data by clock signal, in which related digital circuit elements, such as D flip-flop and RS flip-flop, and embedded system components, such as related chip, network and control device, both comprise delay methods. Accordingly, sampling circuits of traditional digital circuit have to sample in high frequency and adopt parallel-to-serial data conversion with frequency reduction, for the reason that phase lock frequency multiplying circuit is required. However, prior arts include disadvantages in high power consumption, hard design difficulty, long research period, increasing noise and high cost.

### SUMMARY OF INVENTION

One object of the present invention is to provide a control pipeline architecture and a pipeline processing system thereof, which is particularly applicable to digital and analog integrated circuit design flow for hardware implementation.

The other object of the present invention is to provide a neural network architecture based on the control pipeline architecture, which is applicable to digital integrated circuit design flow, and particularly implementable directly by Complex Programmable Logic Device (CPLD) or Field Programmable Gate Array and to integrated circuits.

The other object of the present invention is to provide a sampling module based on the control pipeline architecture, which is applicable to logic analysis, oscilloscope, function generator, integrated circuit or device, and more particularly, is able to increase multiple sampling rate without to increase clock frequency of inner sampling circuit and processor.

The present invention provides a closed loop control pipeline architecture, comprising: a plurality of control units, each of the control units connected in series connection with one another to form a closed loop architecture to link an output of one control unit to an input of the next control unit, and each of the control units having a programmable interconnect input end and a programmable interconnect output end, wherein at least one control unit includes an input end receiving an input signal, and at least one control unit includes an output end outputting an output signal.

The present invention further provides a closed loop pipeline processing system, having a plurality of input nodes and a plurality of output nodes, the pipeline processing system comprising: a plurality of closed loop control pipelines, each of the plurality of closed loop control pipelines comprising: a plurality of control units, each of the control units connected in series connection with one another to form a closed loop architecture, and each of the control units having a programmable interconnect input end and a programmable interconnect output end, wherein, each of the closed loop control pipelines includes a part of input ends to connect with the plurality of input nodes respectively, and each of the closed loop control pipelines includes at least one output end to connect with respective output node.

The present invention provides an open loop control pipeline architecture, comprising: a plurality of control units, each of the control units connected in series connection with one another to form an open loop architecture to link an output of one control unit to an input of the next control unit, and each of the control units having a programmable interconnect input end and a programmable interconnect output end, wherein at least one control unit includes an input end receiving an input signal, and at least one control unit includes an output end outputting an output signal.

The present invention also provides an open loop pipeline processing system, comprising: a first open loop control pipeline, including: a plurality of control units, each of the control units connected in series connection with one another to form an open loop architecture, and each of the control units having a programmable interconnect input end and a programmable interconnect output end, wherein one of the input ends receives an input signal, one of the output ends outputs an output signal, and at least one control unit, between the input signal and the output signal, outputs a center signal via the output end thereof; and at least a second open loop control pipeline, having a assembly architecture the same with the first open loop control pipeline, wherein one input end of the second open loop control pipeline receives the center signal, and at least one control unit, after the input end receiving the center signal, outputs a second output signal via the output end thereof.

In the embodiments of the present invention, a delay module constituted with series connective L flip-flops is used to resolve a problem of logic reduction in a delay module of the digital integrated circuit, and further, the open loop pipeline processing system of the present invention applied in full digital circuits, such as signal multiplying, phase locking or oscillating, is applicable to digital integrated circuit design flow, and especially is implemented in CPLD or FPGA directly. In addition, the open loop pipeline processing system of the present invention feedbacks an center signal generated from the signal processing procedure of the open loop control pipeline architecture as a control signal to the control pipeline or other control pipelines to improve the matter of output uncontrollable of the other control pipeline from the open loop, and keeps the advantage of high operating speed of open loop.

### BRIEF DESCRIPTION OF DRAWINGS

FIG. 1 illustrates a structure of a closed loop programmable control pipeline architecture of the present invention.

FIG. 2A illustrates a block diagram of a typical closed loop control system.

FIG. 2B illustrates a structure of a control pipeline architecture of the present invention equivalent to the closed loop control system disclosed in FIG. 2A.

FIG. 3A illustrates a network diagram of a neural network with a delay feedback.

FIG. 3B illustrates a structure of a control pipeline architecture of the present invention equivalent to an output node of the neural network disclosed in FIG. 3A.

FIG. 4 illustrates a structure of an open loop programmable control pipeline architecture of the present invention.

FIG. 5A illustrates a network diagram of a typical feed-forward neural network.

FIG. 5B illustrates a structure of a control pipeline architecture of the present invention equivalent to an output node of the neural network disclosed in FIG. 5A.

FIG. 6A illustrates a structure of a delay module to implement a delay locking loop by use of NOT gates connected in series connection.

FIG. 6B illustrates a block diagram of a L flip-flop of an embodiment of the present invention and a truth table thereof.

FIG. 6C illustrates a frequency multiplication timing chart of an embodiment of the present invention.

FIG. 7A illustrates a structure of control processing system constituted by open loop programmable control pipelines of a preferable embodiment of the present invention.

FIG. 7B illustrates a structure of control processing system constituted by open loop programmable control pipelines of another preferable embodiment of the present invention.

FIG. 7C illustrates a structure of control processing system constituted by open loop programmable control pipelines of another preferable embodiment of the present invention.

FIG. 8A illustrates a structure of a synchronous frequency multiplying circuit implemented with a preferable embodiment of the open loop pipeline processing system of the present invention applied in CPLD or FPGA.

FIG. 8B illustrates a signal timing chart of the synchronous frequency multiplying circuit disclosed in FIG. 8A.

FIG. 8C and FIG. 8D illustrates respectively an equivalent circuit block diagram of output signal Dl1_out1 and Dl1_out2 of the synchronous frequency multiplying circuit disclosed in FIG. 8A.

FIG. 9 illustrates an equivalent circuit block diagram of the synchronous frequency multiplying circuit implemented from another preferable embodiment of the open loop pipeline processing system of the present invention applied in CPLD or FPGA.

FIG. 10 illustrates a block diagram of a phase locking circuit implemented form a preferable embodiment of the open loop pipeline processing system of the present invention applied in CPLD or FPGA.

FIG. 11 illustrates a block diagram of a phase lock oscillating circuit implemented form a preferable embodiment of the open loop pipeline processing system of the present invention applied in CPLD or FPGA.

FIG. 12 illustrates a block diagram of a phase lock oscillating circuit implemented form another preferable embodiment of the open loop pipeline processing system of the present invention applied in CPLD or FPGA.

FIG. 13 illustrates a block diagram of a synchronous analog circuit implemented by the open loop pipeline processing system of the present invention.

### DETAIL DESCRIPTION OF THE INVENTION

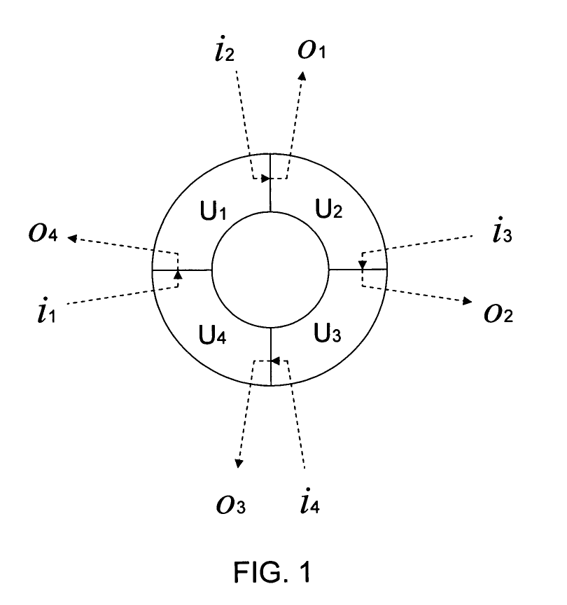

Refers to FIG. 1 on the beginning, which shows a structure diagram of a closed loop programmable control pipeline architecture of the present invention. The closed loop control pipeline architecture of the present invention includes a plurality of control units Uᵢ, and the plurality of control control units Uᵢ connected in series connection to form as a closed loop architecture. Such as four control units as in FIG. 1, caused on the closed loop architecture, an output oᵢ of the control unit Uᵢ is connected with an input iᵢ₊₁ of a next control unit Uᵢ₊₁. And, each control unit Uᵢ includes both one programmable interconnect input end iᵢ and one programmable interconnect output end oᵢ, where these control units have ability of data processing and can perform data transmission in connections between the control pipeline architecture. In which, at lest one control unit receives an input signal via the input end thereof, and at least one control unit outputs an output signal via the output end thereof.

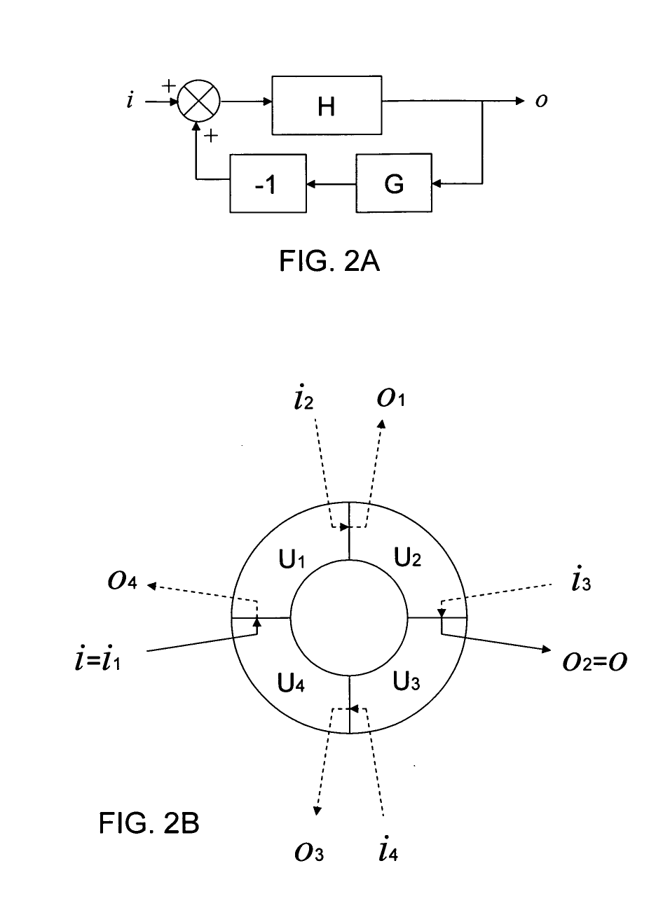

FIG. 2A shows a block diagram of a typical closed loop control system. The typical closed loop control system includes an input i and and an output o, and after a negative feedback gain G, the output o are added into the input i as a adding result, and the adding result forms the output o after a gain H.

In one embodiment of the present invention, the typical closed loop control system disclosed in FIG. 2A can be implemented easily by the closed loop programmable control pipeline architecture disclosed in FIG. 1. FIG. 2B shows a closed loop control pipeline architecture of the present invention equivalent to the closed loop control system disclosed in FIG. 2A, where the closed loop control pipeline architecture includes four control units Uᵢ (i=1, . . . , 4). A control unit U₁ has an input end i₁ defined as an input i of the typical closed loop control system and a control function of the control unit U₁ defined as an adder, and then an output o₁ of the control unit U₁ is transmitted to a next stage control unit U₂. The control unit U₂ has a control function defined as an amplifier with gain H and an output end o₂ defined as an output o of the typical closed loop control system. A control unit U₃ and a control unit U₄ are used to implement a negative feedback gain, wherein the control unit U₃ includes a control function defined as an amplifier with gain G, and the control unit U₄ includes a control function defined as an amplifier with negative unity-gain. Based on the closed loop architecture, an output o₄ with negative feedback gain is transmitted to the control unit U₁.

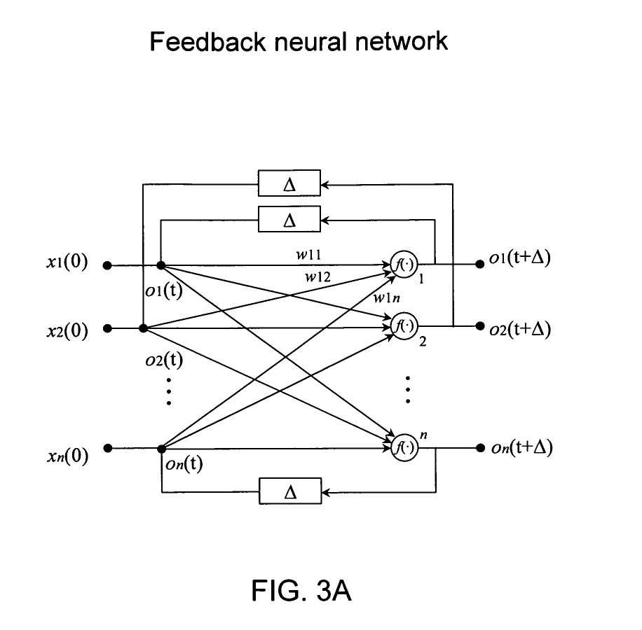

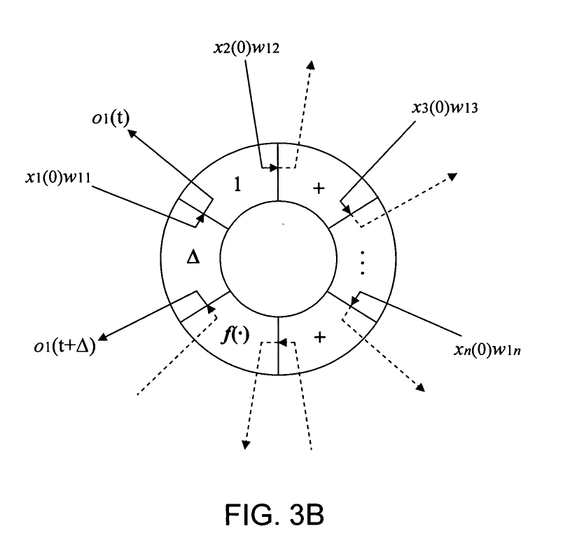

Refers to FIG. 3A, which shows a network diagram of a neural network with delay feedback. The neural network disclosed in FIG. 3A is a two-layer network architecture having first layer input nodes and second layer output node with the same numbers of nodes, wherein the first layer input nodes receive initial values x₁(0) . . . xₙ(0) and output the initial values x₁(0) . . . xₙ(0) in the first time output and remove the initial values x₁(0) . . . xₙ(0) in after, and the second output nodes delay feedback output values o₁(t+Δ) . . . oₙ(t+Δ) to the first layer input nodes as output values. Inputs of the second layer output nodes come from weighted outputs of the first layer input nodes, in which all weighted outputs of the first layer input nodes are synthesized and added as a factor of an activity function ƒ(·) of the second layer output nodes to determine output values of the second layer output nodes.

In the embodiment of the present invention, output nodes of the neural network disclosed in FIG. 3A can be implemented easily by the closed loop programmable control pipeline architecture of FIG. 1. FIG. 3B shows a structure of the closed loop programmable control pipeline architecture of the present invention equivalent to an output node of the neural network disclosed in FIG. 3A. Take the first output node in the implementation of the neural network for example, the closed loop control pipeline architecture is assembled with a plurality of control units Uᵢ, and the control units Uᵢ are series connected with one another to form a closed loop architecture. In the example, one control unit Uᵢ includes a control function defined as an activity function ƒ(·), and an output end oᵢ is used as an output value o₁(t+Δ) of the first output node and is transmitted to a next stage control unit Uᵢ₊₁. The control unit Uᵢ₊₁ includes a control function defined as a delay unit with delay time Δ, and an output end Oᵢ₊₁ defined as an output value o₁(t) of the first output node after the delay time Δ.

After the control unit Uᵢ₊₁, a series connected control unit is processed with accumulating function, and input ends of each control unit are received with weighted initial values x₁(0)w₁₁, . . . , xₙ(0)w₁ₙ, respectively. In the last, the accumulating result is transmitted to the control unit Uᵢ to produce the output value o(t+Δ) by the activity function ƒ(·). With a further description, each initial value x₁(0), . . . , xₙ(0), after the first accumulation, is replaced with the output values o₁(t+Δ), . . . , oₙ(t+Δ) of each output node after the delay time Δ, and that can be implemented by a signal processor or a multiplexer.

Accordingly, based on the closed loop control pipeline architecture disclosed in FIG. 1, the present invention provides a closed loop pipeline processing system with a plurality of input nodes and output nodes, the closed loop pipeline processing system comprising a plurality of closed loop control pipelines, each of the plurality of closed loop control pipelines comprising: a plurality of control units, each of the control units connected in series connection with one another to form a closed loop architecture, and each of the control units having a programmable interconnect input end and a programmable interconnect output end; wherein, each of the closed loop control pipelines includes a part of input ends to connect with a plurality of input nodes respectively, and each of the closed loop control pipelines includes at least one output end to connect with respective output node.

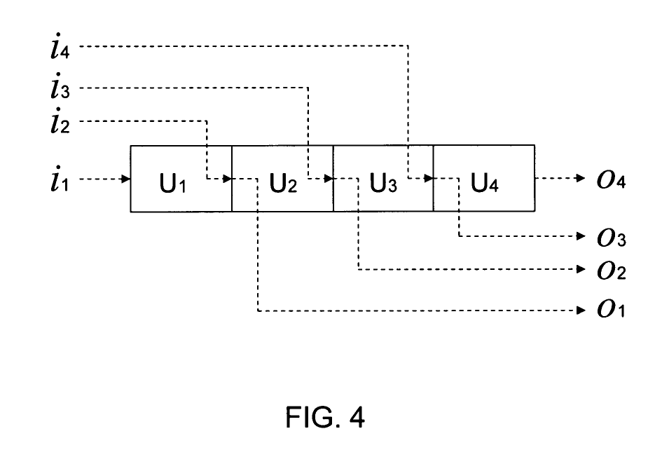

FIG. 4 shows an open loop programmable control pipeline architecture of the present invention. The open loop control pipeline architecture of the present invention includes a plurality of control units Uᵢ, where each of the plurality of control units Uᵢ is series connected with one another to form the open loop architecture. Based on the open loop architecture, an output oᵢ of each control unit Uᵢ connected in sequence to an input iᵢ₊₁ of next stage control unit Uᵢ₊₁ as exampled in four control units disclosed in FIG. 4. In addition, each control unit Uᵢ comprises a programmable interconnect input end iᵢ and a programmable interconnect output end oᵢ. These control units have ability with data processing for data transmission between the control pipeline architecture. Wherein, at lest one control unit receives an input signal with the input end thereof, and at least one control unit outputs an output signal with the output end thereof.

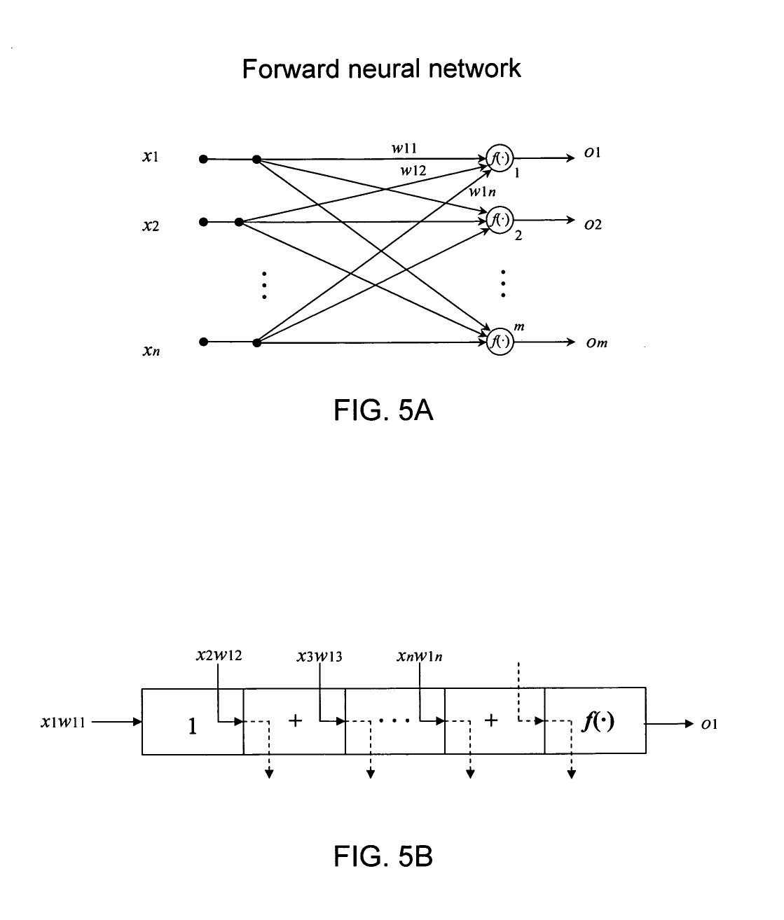

FIG. 5 shows a network architecture of a feed-forward neural network. The neural network displayed in FIG. 5 is a two-layer network architecture, and includes first layer input nodes and second layer output nodes, in which the first layer input nodes receive input values x₁ . . . xₙ and output the received input values x₁ . . . xₙ. The second layer output nodes receive weighted outputs from the first layer input nodes, all weighted outputs of the first layer input nodes are synthesized to be a factor of an activity function ƒ(·) of the second layer output nodes, and output values o₁ . . . oₘ of the second layer output nodes are determined by the activity function ƒ(·).

In the embodiment of the present invention, output nodes of the neural network displayed in FIG. 5 can be easily implemented by the open loop programmable control pipeline architecture displayed in FIG. 4. FIG. 5B shows a architecture of a open loop control pipeline architecture of the present invention equivalent to an output node of the neural network disclosed in FIG. 5, as an example of the first output node in the implementation of the neural network, the open loop control pipeline architecture is constituted with a plurality of control units Uᵢ, and the control units Uᵢ are series connected with one another to form an open loop architecture. In the example, the last control unit Uᵢ includes a control function defined as an activity function ƒ(·), and an output end oᵢ is used as an output value o₁ of the first output node. Before the last control unit Uᵢ, series connected control units are processed with accumulating function and input ends of each control unit receive weighted input values x₁w₁₁, . . . , xₙw₁ₙ respectively. Finally, the accumulating result is transmitted to the control unit Uᵢ to the generate output value o₁ by the activity function ƒ(·).

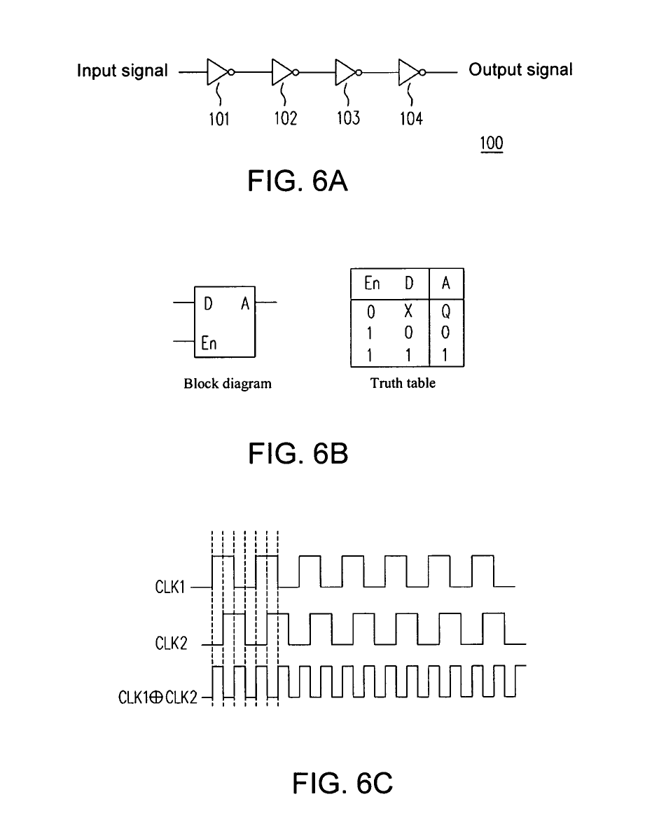

In one embodiment of the present invention, a delay module provided by the open loop control pipeline architecture of the present invention is applicable to digital integrated circuit design flow, and is particularly able to be implemented by CPLD or FPGA directly and applicable to integrated circuit. FIG. 6A shows an architecture of a delay module to implement a delay lock loop by use of open loop control pipeline assembled by NOT gates connected in series connection.

In the present invention, a delay module is assembled with L flip-flops connected in series connection to overcome the matter of logic oversimplification of the delay module in a digital integrated circuit design flow. FIG. 6B shows a block diagram of a L flip-flop of an embodiment of the present invention and a truth table thereof.

Refers to FIG. 6B, the L flip-flop includes an input end D, an enable end En and an output end A. According to the truth table as shown in FIG. 6B, the output end A remains outputting the last output state Q without the consideration of the state of the input end D, so the L flip-flop is called “Disable” when the input end En is logic 0. In another circumstance, when the input end En is logic 1, if the input end D is logic 0 then the output end A follows the input end D to become logic 0, and if the input end D is logic 1 then the output end A follows the input end D to become logic 1, therefore the L flip-flop is called “Enable” when the input end En is logic 1. Of course, the L flip-flop can be designed as “Enable” when the input En is logic 0 and “Disable” when the input En is logic 1. Moreover, the output A can be designed to change with response to the reverse value of the input D when the D flip-flop is Enable. In real applications, the L flip-flop further requires a reset signal to reset initial state, however, a reset end for receiving the reset signal is not displayed but which can be easily understood by those people skilled in the art.

According to the truth table displayed in FIG. 6B, the same with Logic Gate, the L flip-flop is an non-synchronous element with no requirement of clock frequency and therefore has minimum delay time, and jitter, such as in prior art, is eliminated since the clock frequency is non-essential and has no use for holding a basic time like D flip-flop does. A delay module assembled by L flip-flops can be compiled and verified by software directly, and be wrote into CPLD or FPGA for circuit verification to reduce long design period with high reliability. Of course, an Application Specific Integrated Circuit (ASIC) can be applied, wherein compilation and verification with hardware description language is used first, then a synthesizing software and auto-layout software are used to accomplish the circuit physical layout, and a chip is generated to finish circuit physical verification.

FIG. 6C shows a frequency multiplication timing chart, in which an operator label ⊕ represents an exclusive-or (XOR) operation. Refers to FIG. 6C, CLK1 is an initial input frequency, which becomes CLK2 after a time delay. After the XOR operation with CLK1 and CLK2, a frequency multiplication effect is produced with advantages of power saving (operation is happened when the input is in transition, and a constant is outputted when no input occurs) and without accumulation error (phase locked in every half cycle, which is calibrated in every half cycle). In fact, the XOR operation has self delay time, which requires a control mechanism to control the delay time between CLK1 and CLK2 disclosed in FIG. 6C. An open loop pipeline processing system is illustrated first in the following, where the open loop pipeline processing is cooperated with a delay module assembled with the L flip-flops to implement signal frequency multiplying, phase locking, and oscillating in CPLD or FPGA directly. Besides, the pipeline processing system can be applied further in analog application, such as modulation or de-modulation.

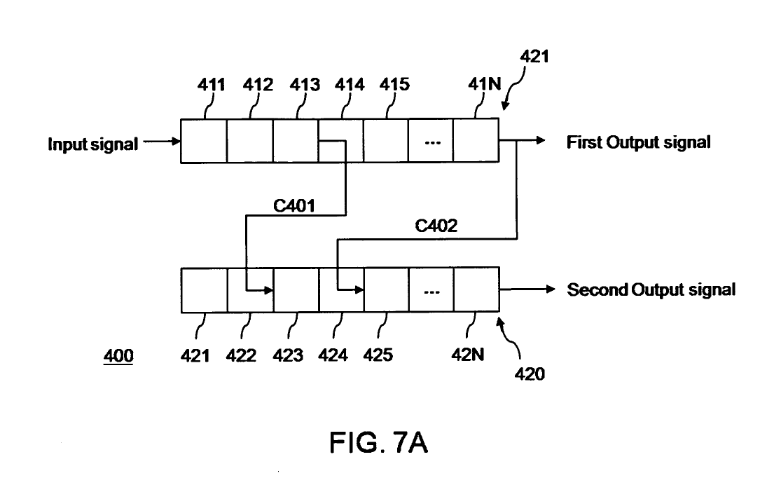

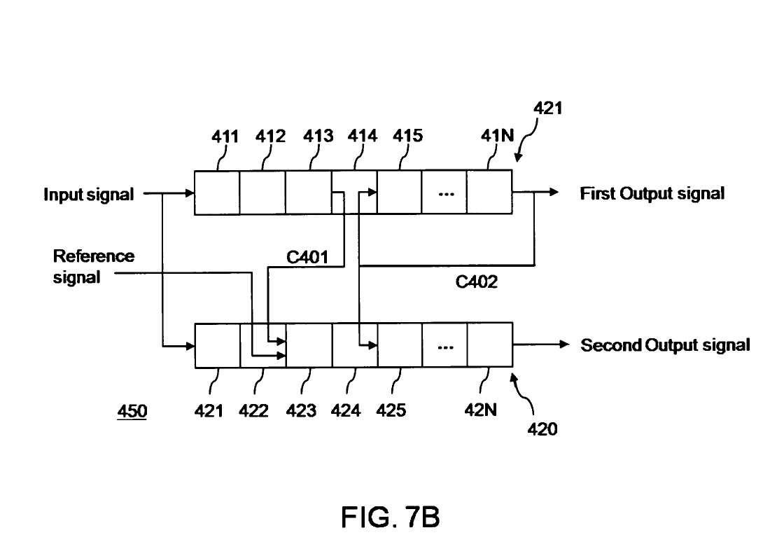

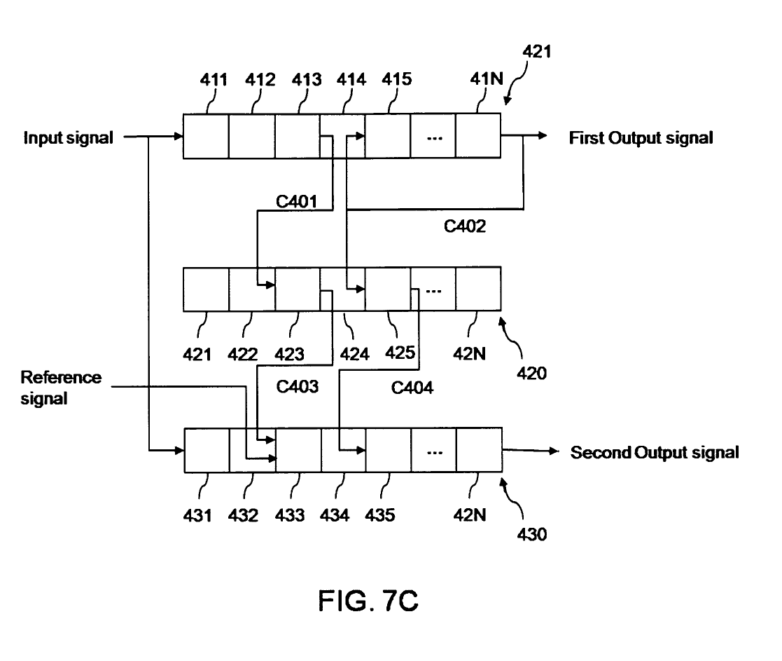

FIG. 7A shows an architecture of pipeline processing system constituted by an open loop programmable control pipeline of a preferable embodiment of the present invention. Refers to FIG. 7A, an open loop pipeline processing system 400 includes a first control pipeline 410 and a second control pipeline 420 with almost the same delay time, wherein “almost” means the same delay time between the control pipelines 410 and 420, or approximate delay time between the control pipelines 410 and 420 without output error. For simple description of the present invention, the word “the same” is used to replace “almost the same” in the following.

In order to make the description of embodiments of the present invention more clearly, an embodiment includes the first control pipeline 410 and second control pipeline 420 with the same delay time is illustrated in the following. The first control pipeline 410 comprises control units 411˜41N, and the second control pipeline 420 comprises control units 421∥42N, wherein N is an nature number and the control units 411 and 421, 412 and 422, . . . , 41N and 42N have the same delay time respectively. The control unit 411 receives an input signal, the control unit 41N outputs a first output signal, and the control unit 42N outputs a second output signal. The control circuit function of these control units are digital elements, such as transmission gate, logic gate, flip-flop, tri-state gate, register or logic array, or analog elements, such as various kinds of amplifier, filter and regulation circuit or VCO, or even invalid element to make the control pipeline thereof having a delay time the same with other control pipelines.

The normal open loop control apparatus has an operating rate much faster than other closed loop control apparatus because of no output signal feedback for control, but is unable to be controlled or calibrated when an output error occurs. Further refers to FIG. 7A, the open loop pipeline processing system 400 of the present invention takes at least one center signal as a control signal, and feedbacks the control signal by one control pipeline to other control pipelines as an new control parameter of other control pipelines for controlling the output thereof. For example, the control unit 413 of the first control pipeline 410 feedbacks a center signal C401 to the control unit 423 of the second control pipeline 420, so that the output of the second control pipeline (which means second output signal) is controlled and the delay time of the second control pipeline 420 is the same with which of the first control pipeline 410. The open loop pipeline processing system 400 of the present invention also can feedback an output of one control unit as a control signal to other control pipelines. For example, output of the first control pipeline 410 (which is the first output signal) is feedback as a control signal C402 to the control unit 425 of the second control pipeline 420, which can be used to real-time analyze difference between the output with loads and the desired output of the control pipeline, and is helpful for controlling adjustment and analysis of control pipelines.

In the first control pipeline 410 and the second control pipeline 420, the working rates are very fast because of the open loop control methods, and the control pipeline 410 feedbacks the center signal C401 and the control signal C402 to the second control pipeline 420 to provide a new control parameter to the second control pipeline 420 for controlling the output thereof precisely.

FIG. 7B shows an architecture of a pipeline processing system constituted by an open loop programmable control pipeline of another preferable embodiment of the present invention. Refers to FIG. 7B, an open loop pipeline processing system 450 has the same hardware architecture with the open loop pipeline processing system 400 disclosed in FIG. 7A and shares the same element labeling number. The control signal C402 feedbacks not only to the control unit 425 of the second control pipeline 420 but also to the control unit 415 of the first control pipeline 410 to form a closed loop control pipeline. Therefore, the embodiment is a hybrid application of the open loop control pipeline architecture and the closed loop control pipeline architecture of the present invention.

Besides, the first control pipeline 410 and the second control pipeline 420 receive the same input signal. The open loop pipeline processing system 450 further receives an external reference signal as an input of internal control units, such that the control unit 423 of the second control pipeline 420 further receives a reference signal to make the design of the open loop pipeline processing system 450 more diversification.

FIG. 7C shows an architecture of pipeline processing system constituted by an open loop programmable control pipeline of another preferable embodiment of the present invention. An open loop pipeline processing system disclosed in FIG. 7C includes a first control pipeline 421, a second control pipeline 420 and a third control pipeline 430, wherein the first control pipeline 421 receives the same input signal with the third control pipeline 430, the center signal C401 of the first control pipeline 421 and the control signal C402 are the same with which disclosed in the embodiment of FIG. 7B, and center signals C403 and C404 of the second control pipeline 420 feedback to control units 433 and 435 of the third control pipeline 430. In further, the control unit 433 of the third control pipeline 430 can receive an external reference signal.

The open loop pipeline processing systems disclosed in FIG. 7A, 7B and 7C can further extend to two or more than three control pipelines as long as the control pipelines share the same delay time and every center signal or control signal of each control pipeline feedback to other control pipeline. The control signal can even adopted with jump method, for example, the control signal send from the first control pipeline can transmit to the third control pipeline with skipping the adjacent second control pipeline. Moreover, the open loop pipeline processing system can receive every output of each control pipeline with a signal processor and processed with signal processing. By making a proper use, the control units and control signals can use random and stepless signal phase locking, can control the delay phase locking time randomly, and synthesize, decompose signals or generate phase lock frequency multiplication with applicable to analog, digital or mixed circuit design. The way to apply the open loop pipeline processing system to a phase lock frequency multiplying circuit, and implement directly in CPLD or FPGA is disclosed as follows.

After an analysis of internal circuit architectures of CPLD and FPGA, the architecture of CPLD can be realized with nothing but an input PAD, internal wire bounding array, logic gate array, specific gate (OR gate, XOR gate), register, tri-state gate and output PAD. Each delay time of each part of the CPLD architecture has specification for inquiry, and FPGA architecture is different from CPLD architecture merely with the replacement of the logic gate by multiplexer. According to the specification, because each of the shortest path in CPLD and FPGA is the same so that the delay times of CPLD and FPGA from input to output are remain constant, which are both very suitable for the application of the open loop pipeline processing system of the present invention. Numbers of embodiments for the open loop pipeline processing system of the present invention applied in frequency multiplying circuit, phase locking circuit and oscillating circuit are illustrated in the follows, wherein the embodiments can be implemented by CPLD or FPGA directly.

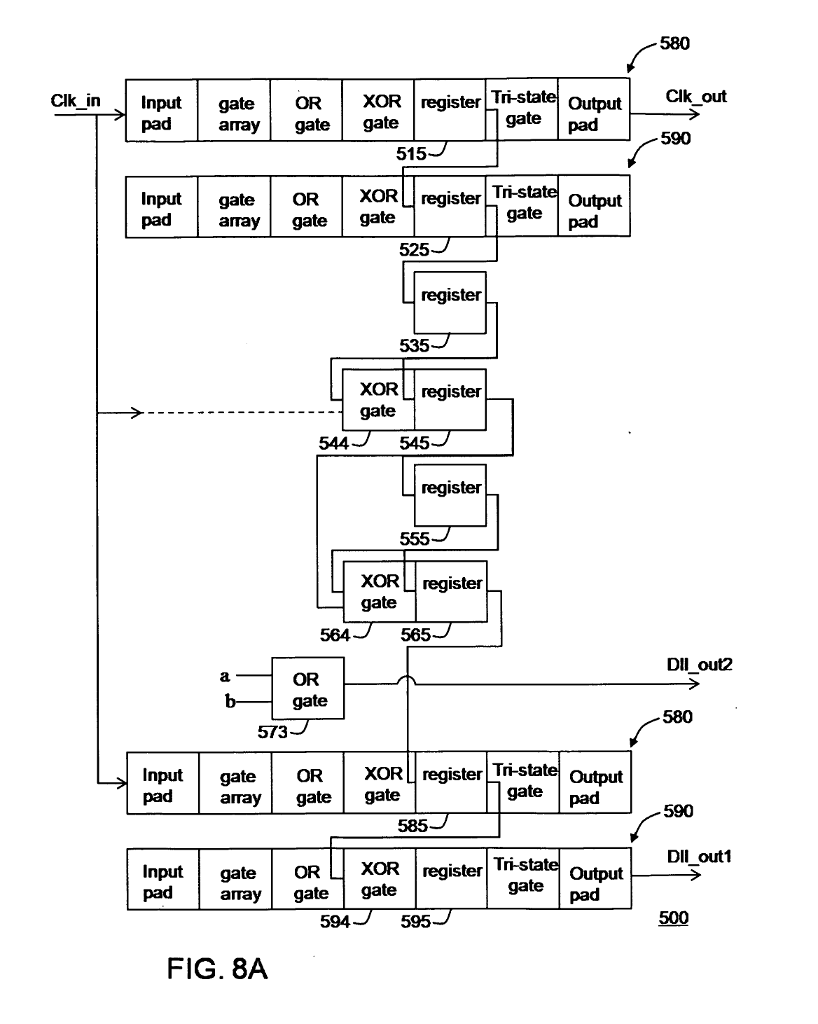

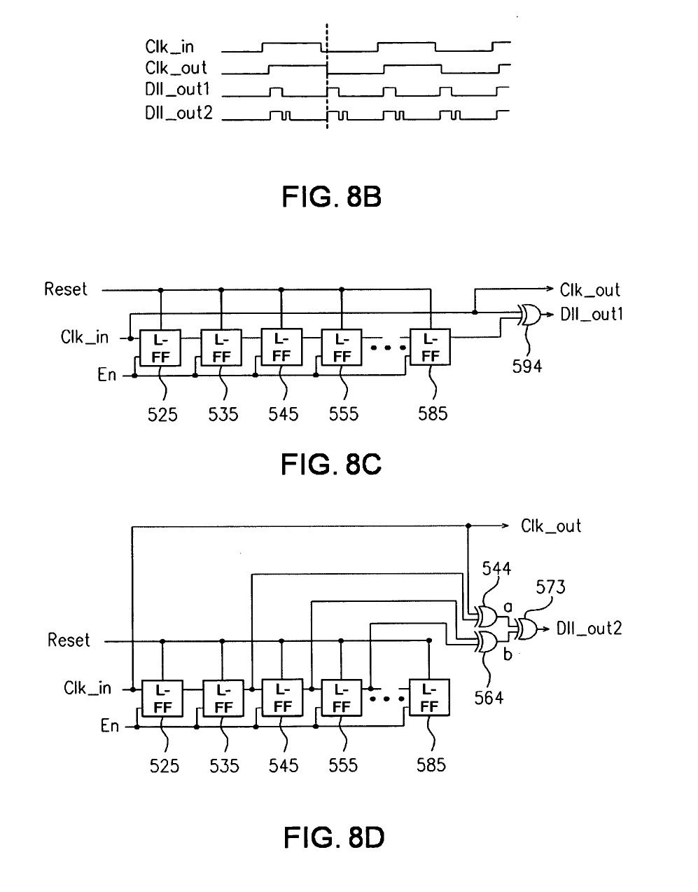

FIG. 8A shows a structure of a synchronous frequency multiplying circuit implemented from a preferable embodiment of the open loop pipeline processing system of the present invention applied in CPLD or FPGA. Refers to FIG. 8A, in further clear description of the present invention, take a synchronous frequency multiplying circuit 500 implemented by the open loop pipeline processing system with nine same open loop control pipelines for example, which means each control pipeline having the same assembled control units. Wherein, the full line arrow represents the input and output signal of the control pipeline, the dotted line arrow means that the signal passes through one control unit of the control pipeline but the control unit is not shown, and the control unit sketched with full line rectangle represents one control unit of the control pipeline but other elements of the control pipeline are passed over.

The synchronous frequency multiplying circuit 500 includes a first control pipeline 510, a second control pipeline 520, . . . , a eighth control pipeline and a ninth control pipeline. Because each control pipeline represents a path from input to output of CPLD or FPGA, all control pipelines have the same delay time, and include control units of an input PAD, logic gate array, OR gate, XOR gate, register, tri-state gate and output PAD. Every register of each control pipeline is designed as the L flip-flop as mentioned above to overcome the matter of logic oversimplification of the delay module by series connecting a plurality L flip-flops to form a delay module. In some case, other control units may insert into the series connection of the L flip-flops, and the delay time still can be inferred by the specification.

With comparison of FIG. 6C, a first output signal Clk_out outputted from the first control pipeline 510 in FIG. 8A equals to CLK1 in FIG. 6C, and a signal of an input signal Clk_in in FIG. 8A after the delay module (constituted with L flip-flops 525, 535, 545, 555, 565 and 585) equals to CLK2 in FIG. 6C. Therefore, a ninth output signal Dl1_out1 of the ninth control pipeline 590 in FIG. 8A equals CLK1 and CLK2 in FIG. 6C with XOR operation. A precisely signal timing chart of the synchronous frequency multiplying circuit 500 is showed in FIG. 8B. In referring to FIG. 8B, delay time between Clk_in, Clk_out, Dl1_out1, Clk_in and Clk_out is caused from the first control pipeline 510, wherein Clk_out and Dl1_out1 have the same phase and Dl1_out1 has double synchronous frequency of Clk_out, so as to obtain frequency multiplication. Furthermore, asynchronous frequency multiplication can be obtained with other control units and control signals.

Besides, delay time of the delay module can be controlled with adding or reducing numbers of series connected L flip-flops to generate 50% or random duty cycle clock frequency. Also, combinations of other control units and control signals can be used to generate various outputs, for example the output signal Dl1_out2 in FIG. 8A is generated from the result of OR gate 573 operation with signal a and signal b, and FIG. 8B shows the signal timing chart thereof. In which, signal a is generated from the result of XOR operation with Clk_in and another Clk_in after the delay of L flip-flops 525 and 535, signal b is generated from the result of XOR operation with Clk_in after the delay of L flip-flops 525, 535, and 545, and another Clk_in after the delay of L flip-flops 525, 535, 545, and 555.

FIG. 8C and FIG. 8D shows respectively an equivalent circuit block diagram of the output signal Dl1_out1 and Dl1_out2 disclosed in FIG. 8A, wherein the same control units in FIG. 8A, FIG. 8C and FIG. 8D are labeled as same element symbols. Refers to definition of FIG. 8B, FIG. 8C and FIG. 8D are further sketched with signal Reset to reset the L flip-flop, and input D, EN and output A of the L flip-flop are not showed in the equivalent circuit block diagram.

In reference with FIG. 8A, the delay time between the output Clk_out of the first control pipeline 510 and the output Dl1_out1 of the ninth control pipeline 590 is generated from the L flip-flops 525, 535, 545, 555, 565 and 585 (the L flip-flops 515 and 595 contributes the same delay to the first and ninth control pipeline 510, 590 respectively, therefore have no contribution with the delay time between Clk_out and Dl1_out1), and the equivalent circuit diagram is disclosed in FIG. 8C. Sameness, without detail description, the equivalent circuit block diagram of the output signal Dl1_out2 in FIG. 8A is disclosed in FIG. 8D.

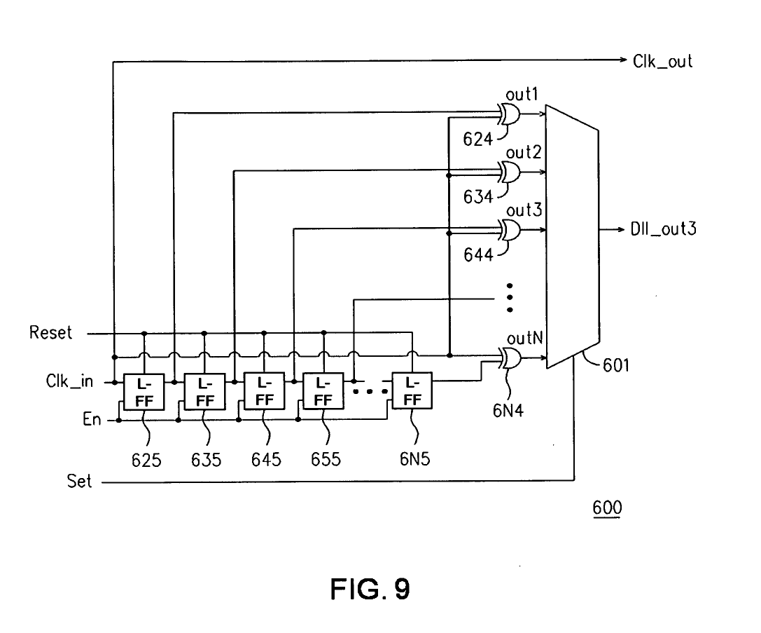

FIG. 9 shows an equivalent circuit block diagram of the synchronous frequency multiplying circuit implemented from another preferable embodiment of the open loop pipeline processing system of the present invention applied in CPLD or FPGA. A synchronous frequency 600 further comprises a signal processor, such as multiplexer 601, where a L flip-flop 625 and a XOR gate 624 represent control units of the first control pipeline, a L flip-flop 635 and a XOR gate 634 represent control units of the second control pipeline, . . . and a L flip-flop 6N5 and a XOR gate 6N4 represent control units of the Nth control pipeline, in which N represents an nature number. Outputs out1˜outN have the same duty cycle, but output delay of the L flip-flops 625˜6N5 received from the XOR gate 624˜6N4 are different (in fact, two adjacent signals are different with one delay time of one L flip-flop, therefore starting times of the outputs out1˜outN are different, and adjacent outputs are different with one delay time of one L flip-flop). By use of reset signal Set to control the multiplexer 601 to choose outputs out1˜outN can set delay time or frequency multiplication of output Dl1_out3.

When the multiplexer 601 is replaced of OR gate in the synchronous frequency multiplication 600, and receives signal out1, out3, out5, . . . (or out2, out4, out6, . . . ) by the OR gate, then output signal of the OR gate of the synchronous frequency multiplication 600 can obtain oscillation of 50% duty cycle without VCO but with low power consumption, and can be implemented with CPLD or FPGA directly. Of course, the oscillating times after phase locking can be adjusted different from 50% duty cycle to be applied in asynchronous data determination and digital or analog synchronous filtering output.

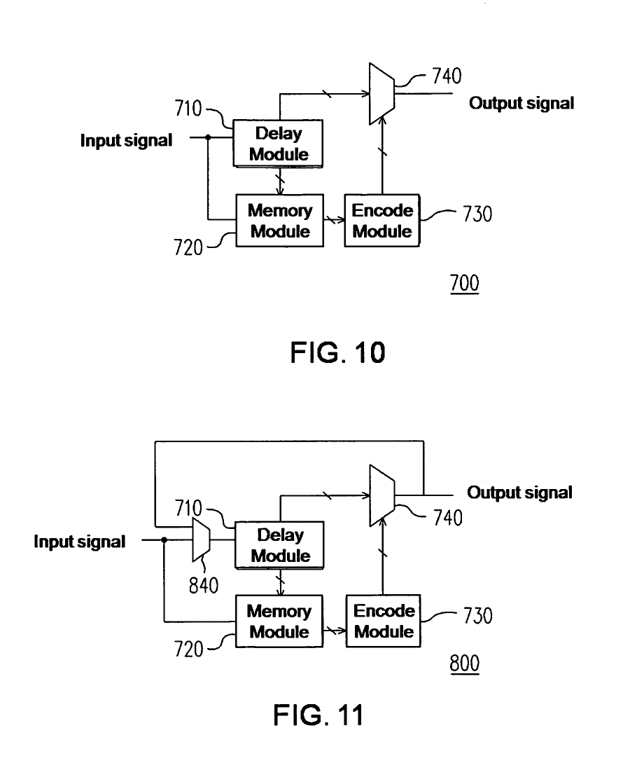

FIG. 10 shows a block diagram of a phase lock circuit implemented from a preferable embodiment of the open loop pipeline processing system of the present invention applied in CPLD or FPGA. Refers to FIG. 10, a phase locking circuit 700 includes a delay module 710, a memory module 720, a encode module 730 and a multiplexer 740. The delay module 710 is constituted with series connected L flip-flops, such as the delay module compose by L flip-flops 525, 535, . . . and 585 in FIG. 8A. Outputs of all L flip-flops in the delay module 710 are signals with various delay times generated from input signal, difference between each two adjacent L flip-flops output signal is a delay time of one 1 flip-flop, and then the signals with various delay times are transmitted to the memory module 720 and the multiplexer.

The memory module 720 can be constituted by L flip-flops or D lip-flops, which merely have difference in that the L flip-flop is level-sensitive and the D flip-flop is edge-trigger but have the same effect for data memory in the phase locking circuit 700. Therefore, the memory module constituted with L flip-flops is exampled in the following, and more particularly is enabled when the enable signal is in high voltage level for convenient illustration of embodiments. Input of each L flip-flop of the memory module 720 receives every output of respective L flip-flop of the delay module 710, and enable end of each L flip-flop receives the input signal. When the input signal is in high voltage level, output of each L flip-flop of the memory module 720 is the same with output of each L flip-flop of the delay module 710. If a transition of the input signal has occurred, the memory module 720 can holds (or memories) every output of each L flip-flop, and numbers of L flip-flop delay times are known, so as to determinate the number of the input signal hold on high voltage level. Furthermore, the output of each L flip-flop on the memory module 720 can be processed with encode by use of the encode module 730, for that the multiplexer 740 is controlled to choose and output signal from signals with various delay times of the delay module 710 approached to the input signal for phase locking.

FIG. 11 shows a block diagram of a phase lock oscillating circuit implemented form a preferable embodiment of the open loop pipeline processing system of the present invention applied in CPLD or FPGA. Refers to FIG. 11, a phase lock oscillating circuit 800 just has one multiplexer 840 more than the phase locking circuit 700 disclosed in FIG. 10. First of all, the multiplexer 840 choose an input signal (such as clock frequency) and send to the phase lock oscillating circuit 800, and then the phase lock oscillating circuit 800, such as the phase locking circuit 700, is processed with phase locking to the input clock frequency. However, when the input signal stop inputting, output signal is feedback by the selection of the multiplexer 849 to generate the same clock frequency for the purpose of oscillation.

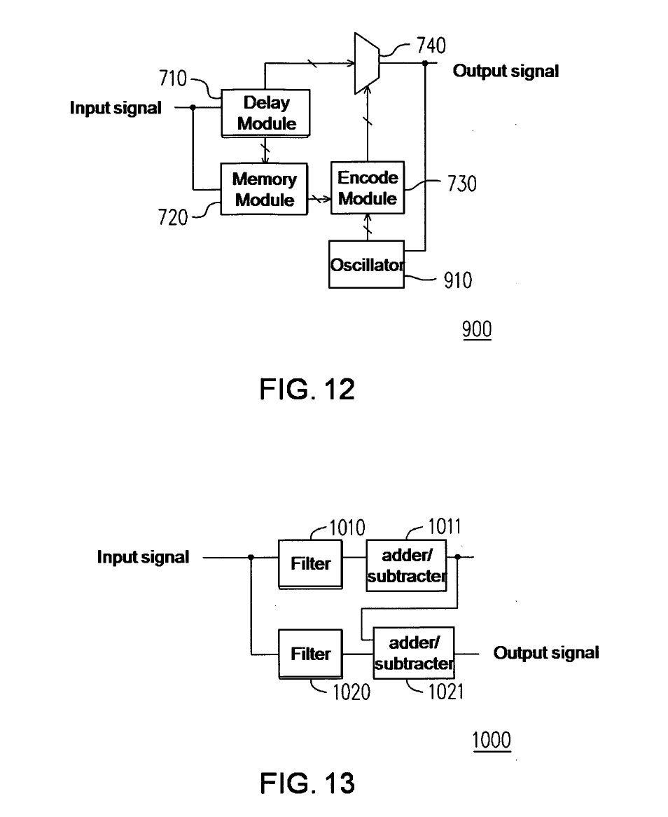

FIG. 12 shows a block diagram of a phase lock resonant circuit implemented form another preferable embodiment of the open loop pipeline processing system of the present invention applied in CPLD or FPGA. Refers to FIG. 12, a phase lock oscillating circuit 900 is another implementation of the phase lock oscillating circuit 800 disclosed in FIG. 11, but unlike the use of the multiplexer 840 in the input of the phase lock oscillating circuit 800, the phase lock oscillating circuit 900 use a oscillator 910 for the purpose of self-oscillation, wherein the oscillator 910 has the same architecture with the delay module 710 but is used to improve signal oscillation. When the memory module 720 and the encode module 730 memories the phase, cycle and duty cycle of the input clock frequency, the output signal can feedback to the oscillator 910 to control the multiplexer 740 through the encode module 730 for the purpose of oscillation.

FIG. 13 shows a block diagram of a synchronous analog circuit implemented in the open loop pipeline processing system of the present invention. Refers to FIG. 13, a synchronous analog circuit 1000 includes a first and a second control pipeline have the same control units, that is a filter 1010 and 1020, and adder-subtracters 1011 and 1021. The filter 1010 and 1020 can be used to filter signal with the part of high frequency (or low frequency), and feedback to the adder-subtracter 1021 by the output of the first control pipeline, which has a time difference with the receiving of the signal from the filter 1020 by the adder-subtracter 1021, therefore to reach synchronous analog signal processing, such as modulation or demodulation.

As mentioned above, the present invention provides a control pipeline architecture and a pipeline processing system thereof, in which the delay module implemented from the open loop control pipeline is constituted of L flip-flops to overcome the matters of simplification of the delay module in the digital integrated circuit design flow. Moreover, the center signal generated from the signal processing procedure of the control pipeline is used to feedback to other control pipelines as a control signal to provide the other control pipelines a new control parameter, which improves the matter of output uncontrollable of the other control pipeline from the open loop, and keeps the advantage of high operating speed from open loop. Besides, the delay module and open loop pipeline processing system of the present invention are applicable to digital integrated circuit design flow, and more particularly can be implemented by CPLD or FPGA, such as in the applications of frequency multiplication, phase locking and oscillation.

Although the present invention has been described in considerable detail with reference to certain preferred embodiments thereof, those skilled in the art can easily understand that all kinds of alterations and changes can be made within the spirit and scope of the appended claims. Furthermore, the present invention is not limited to the implementation of the embodiments exemplified herein.

1. A closed loop control pipeline architecture, comprising:
a plurality of control units, each of the control units connected in series connection with one another to form a closed loop architecture to link an output of one control unit to an input of one next control unit, and each of the control units having programmable interconnect input ends and programmable interconnect output ends, wherein at least one control unit includes an input end receiving an input signal, and at least one control unit includes an output end outputting an output signal.

2. The closed loop control pipeline architecture as claimed in claim 1, wherein a part of the control units connected in series connection are processed with accumulation calculation.

3. The closed loop control pipeline architecture as claimed in claim 1, wherein one of the control units is processed with an activity function.

4. The closed loop control pipeline architecture as claimed in claim 1, wherein at least one control unit, between the control unit receives the input signal and the control unit outputs the output signal, is an negative gain amplifier.

5. The closed loop control pipeline architecture as claimed in claim 1, wherein at least one control unit, between the control unit receives the input signal and the control unit outputs the output signal, is a delay unit with a delay time Δ.

6. The closed loop control pipeline architecture as claimed in claim 1, wherein the control units are adders, amplifiers or delay units, or the combination thereof.

7. The closed loop control pipeline architecture as claimed in claim 1, which is applicable to digital integrated circuit design flow and analog integrated circuit design flow.

8. The closed loop control pipeline architecture as claimed in claim 7, wherein the digital integrated circuit design flow is implemented by a programmable logic device (PLD) directly.

9. A pipeline processing system, having a plurality of input nodes and a plurality of output nodes, the pipeline processing system comprising:
a plurality of closed loop control pipelines, each of the plurality of closed loop control pipelines comprising:
a plurality of control units, each of the control units connected in series connection with one another to form a closed loop architecture, and each of the control units having a programmable interconnect input end and a programmable interconnect output end;
wherein, each of the closed loop control pipelines includes a part of input ends to connect with the plurality of input nodes respectively, and each of the closed loop control pipelines includes at least one output end to connect with one individual output node.

10. The pipeline processing system as claimed in claim 9, wherein a part of the control units connected in series connection of the closed loop control pipelines are processed with accumulation calculation.

11. The pipeline processing system as claimed in claim 9, wherein one of the control units is processed with an activity function.

12. An open loop control pipeline architecture, comprising:
a plurality of control units, each of the control units connected in series connection with one another to form an open loop architecture to link an output of one control unit to an input of one next control unit, and each of the control units having a programmable interconnect input end and a programmable interconnect output end, wherein at least one control unit includes one input end receiving an input signal, and at least one control unit includes one output end outputting an output signal.

13. The open loop control pipeline architecture as claimed in claim 12, wherein the control units are Exclusive-OR (XOR) gate, AND gate, OR gate or the combination thereof, and outputs of the control units can be synchronous or asynchronous.

14. The open loop control pipeline architecture as claimed in claim 13, which is applicable to digital integrated circuit design flow and analog integrated circuit design flow.

15. The open loop control pipeline architecture as claimed in claim 14, wherein the digital integrated circuit design flow is implemented by a programmable logic device (PLD) directly.

16. The open loop control pipeline architecture as claimed in claim 15, wherein the programmable logic device includes a Field Programmable Gate Array (FPGA).

17. The open loop control pipeline architecture as claimed in claim 15, wherein the programmable logic device includes a Complex Programmable Logic Device (CPLD).

18. A pipeline processing system, comprising:
a first open loop control pipeline, including: a plurality of control units, each of the control units connected in series connection with one another to form an open loop architecture, and each of the control units having a programmable interconnect input end and a programmable interconnect output end, wherein one of the input ends receives an input signal, one of the output ends outputs an output signal, and at least one control unit between the input signal and the output signal outputs a center signal via the output end thereof; and
at least a second open loop control pipeline, having a assembly architecture the same with the first open loop control pipeline, wherein one input end of the second open loop control pipeline receives the center signal, and at least one control unit after the input end receiving the center signal outputs a second output signal via the output end thereof.

19. The pipeline processing system as claimed in claim 18, further comprising a signal processor to receive the first and second output signal for signal processing, and to output an output signal.

20. The pipeline processing system as claimed in claim 18, wherein at least one of the first and second control pipeline receives a reference signal for controlling at least one of the first and second control pipeline.
